(19) United States
(12) Patent Application Publication
(10) Pub. No.: US 2015/0358063 A1
(43) Pub. Date: Dec. 10, 2015

(54) Reduction Of Interference In A Wireless Network Through Spectrum Analysis And Transmit Beamforming

(71) Applicant: Collision Communications, Inc., Peterborough, NH (US)

(72) Inventors: Joseph Farkas, Merrimack, NH (US); Brandon Hombs, Merrimack, NH (US)

(73) Assignee: Collision Communications, Inc., Peterborough, NH (US)

(21) Appl. No.: 14/299,517

(22) Filed: Jun. 9, 2014

(51) Int. Cl. H04B 7/06; H04B 7/04

(52) U.S. Cl. CPC H04B 7/0617; H04B 7/0456

(57) ABSTRACT

A method and system are described for optimizing signal strength of a beam-formed wireless network transmission at intended receiver(s) while reducing unintended interference with unintended receiver(s), without requiring high speed exchange of information between nodes. The method is operable by a multi-antenna node of a wireless network in which nodes use the same spectrum for both transmitting and receiving, so that the channel information between the nodes is reciprocal. This allows transmit channel information to be directly determined from signals received from unintended receivers. Scheduling information about the unintended receivers can also be estimated based on the received signals, for example by assuming that the unintended receivers will transmit as frequently as they receive, and/or by obtaining scheduling information from handshake signals or packet headers of the received signals. The precoding matrix can minimize the transmission at one or more unintended receiver and/or maximize a sum capacity of the transmission.

### FIELD

The subject matter disclosed relates to wireless networks, and more particularly, to methods of operating nodes in wireless network.

### BACKGROUND

Many modern wireless networks operate in significant self-interference environments, whereby transmissions of wireless signals by a transmitting node to an intended receiver in the network can interfere with reception of wireless signals by other “interfering” nodes in the network that are not the intended receivers. Note that the term “interfering node” is used herein to refer to a node that is not an intended receiver of a transmission, but is subject to interference from a transmitting node when the interfering node is receiving. The term does not necessarily refer to a node that might interfere with other nodes when it is transmitting, although that possibility is not excluded.

In order to reduce this self-interference and increase network traffic capacity, nodes in a wireless network sometimes include multiple antennae, so that directional patterns can be imposed on wireless transmissions and receptions to enhance signal strength for intended receivers. This approach is referred to herein as “beam-forming.”

Typically, a node implements beam-forming of a transmission by constructing a “precoding matrix” whose dimensions correspond to the number of transmission channels and the number of available antennae. Note that, as used herein, the term “a transmission channel” refers to an individual data stream that is intended to be mapped to antenna elements. The precoding matrix is then used to apportion the transmission channels to the transmitting antennae, and to impose a spatial transmission pattern on each transmission channel by adjusting the phases and amplitudes of each transmission channel on each transmitting antenna.

In order to perform effective transmit beam-forming, it is helpful for a transmitting node to have certain information, including information about which node or nodes are the intended receivers, about the channel conditions from the transmitting node to the receiving node or nodes, and about any other “interfering nodes” which are not intended receivers, but which may nevertheless be within the range of the transmission. Unfortunately, the success of beam-forming can be limited in many networks, because the transmitting nodes are missing some or all of this key information.

A common configuration of a wireless network is shown in FIG. 1, where node A 100 is transmitting to node C 104 and node B 102 is transmitting to Node D 106. Node A may configure its beam-forming to maximize its transmitted signal at node C, and node B may configure its beam-forming to maximize its transmitted signal at node D. However, node A will often have little or no knowledge about node D, and likewise node B will often have little or no knowledge about node C, so that nodes A and B may unintentionally create interference to nodes D and C, respectively.

If transmitting nodes A and B had full knowledge about receiving nodes D and C, respectively, and the corresponding channel conditions, then node A could further optimize its precoding matrix to reduce interference with node D, and node B could further optimize its precoding matrix to reduce interference with node C. Typically though, nodes A and B will determine their precoding matricies without knowledge of those receivers (C and D) that they are interfering with.

A simple example is illustrated in FIG. 2. In the figure, node A has created a beam-formed spatial transmission pattern 200 that maximizes the transmitted signal at node C. However, because node A has no information regarding node D, node A has not taken node D into account when determining its precoding matrix, and has inadvertently selected a beam-forming pattern 200 that also provides a strong signal at the location of node D.

This scenario occurs across a wide range of wireless network systems, such as uplink and downlink in hub-and-spoke systems including cellular, wifi, and wimax, as well as in adhoc networks. For example, FIG. 3 illustrates a pair of adjacent cells 300, 302 in a cellular communication network where base station A 304 is transmitting to user equipment C 308 and base station B 306 is transmitting to user equipment D 310. As illustrated in the figure, base station A will interfere with user equipment D, and base station B will interfere with user equipment C, at least in part because the base stations (304, 306) have little or no knowledge about user equipment located outside of their own cells.

Some advanced systems have progressed to where transmitting nodes are provided with scheduling and channel information that is applicable to other nodes in the network. For example, high speed interfaces are deployed with Coordinated Multipoint Systems, and can be used to provide this information. However, this approach requires adding expensive high speed interfaces to the network that can share and distribute information among nodes, which is infeasible in many cases. In addition, this approach does not provide channel information, which is also key to optimal beam-forming.

What is needed, therefore, is a method for determining beam-forming precoding matrices that optimizes signal strength at intended receivers while reducing interference with unintended receivers in a wireless network, without requiring high speed exchange of information between the nodes.

### SUMMARY

Accordingly, a method and system are described for determining beam-forming precoding matrices that optimizes signal strength at intended receivers while reducing interference with unintended receivers in a wireless network, without requiring high speed exchange of information between the nodes. Note that the term “interfering node” is used herein to refer to a node that is not an intended receiver of a transmission, but is subject to interference from a transmitting node when the interfering node is receiving.

The claimed method is operable by a wireless network node to reduce interference with one or more interfering nodes that utilize the same spectrum for both transmitting and receiving. Because the interfering nodes uses the same spectrum for both transmitting and receiving, the channel information between the transmitting node and the interfering nodes is reciprocal, which allows transmit channel information to be directly measured based on signals received from the interfering nodes. Scheduling information about the interfering nodes can also be predicted based on the received signals, for example by assuming that the interfering nodes will transmit more or less as frequently as they receive, and/or by intercepting certain scheduling information exchanged between nodes. Once the channel information has been measured, and the scheduling information has been predicted, this information can be used to calculate a precoding matrix that will minimize interference with the interfering node(s) while optimizing signal strength at the intended receiving node(s).

According to an exemplary embodiment, a method is described of operating a first wireless network node having N transmitting antennae. The method includes receiving a signal from an interfering node to which the first wireless network node is not connected, determining from the received signal interference information that pertains to the interfering node, determining a transmission to be sent to a second wireless network node, said transmission including M transmission channels, calculating a precoding matrix based at least in part on the interference information, said precoding matrix having dimensions M and N, said precoding matrix being calculated according to a precoding strategy, applying the precoding matrix to the transmission, thereby determining a phase, amplitude, and apportioning of the transmission channels to the transmitting antennae that impose a spatial transmission pattern on the transmission, said spatial pattern being configured to reduce interference of the transmission at the interfering node, and sending the transmission to the second wireless network node.

The precoding strategy can include minimizing an amplitude of the transmission at a location of the interfering node, averaging previously calculated covariance matrices of interfering nodes and calculating the precoding matrix using a sample matrix inversion technique, selecting one or more strong interferers for which the signal should be minimized, and/or maximizing a sum capacity of the transmission.

In embodiments, the nodes in the wireless network use the same spectrum for both transmitting and receiving. In some of these embodiments this is accomplished by implementing at least one of time division duplex communication, time division multiple access communication, and full duplex communication.

According to another exemplary embodiment, a first wireless network node is described that includes a transmitter, a receiver, N transmitting antennae, and a controller coupled to the transmitter, receiver, and antennae. Together, these elements are configured to receive a signal from an interfering node to which the first wireless network node is not connected, determine from the received signal interference information that pertains to the interfering node, determine a transmission to be sent to a second wireless network node, said transmission including M transmission channels, calculate a precoding matrix based at least in part on the interference information, said precoding matrix having dimensions M and N, said precoding matrix being calculated according to a precoding strategy, apply the precoding matrix to the transmission, thereby determining a phase, amplitude, and apportioning of the transmission channels to the transmitting antennae that impose a spatial transmission pattern on the transmission, said spatial pattern being configured to reduce interference of the transmission at the interfering node, and send the transmission to the second wireless network node.

In embodiments, the nodes in the wireless network use the same spectrum for both transmitting and receiving. In some of these embodiments this is accomplished by implementing at least one of time division duplex communication, time division multiple access communication, and full duplex communication.

According to yet another exemplary embodiment, a non-transitory computer readable medium is described that is storing a computer program executable by a machine, for operating a first wireless network node having N transmitting antennae. The computer program includes executable instructions for receiving a signal from an interfering node to which the first wireless network node is not connected, determining from the received signal interference information that pertains to the interfering node, determining a transmission to be sent to a second wireless network node, said transmission including M transmission channels, calculating a precoding matrix based at least in part on the interference information, said precoding matrix having dimensions M and N, said precoding matrix being calculated according to a precoding strategy, applying the precoding matrix to the transmission, thereby determining a phase, amplitude, and apportioning of the transmission channels to the transmitting antennae that impose a spatial transmission pattern on the transmission, said spatial pattern being configured to reduce interference of the transmission at the interfering node, and sending the transmission to the second wireless network node.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 is a simplified diagram illustrating communication between nodes in a wireless network according to the prior art;

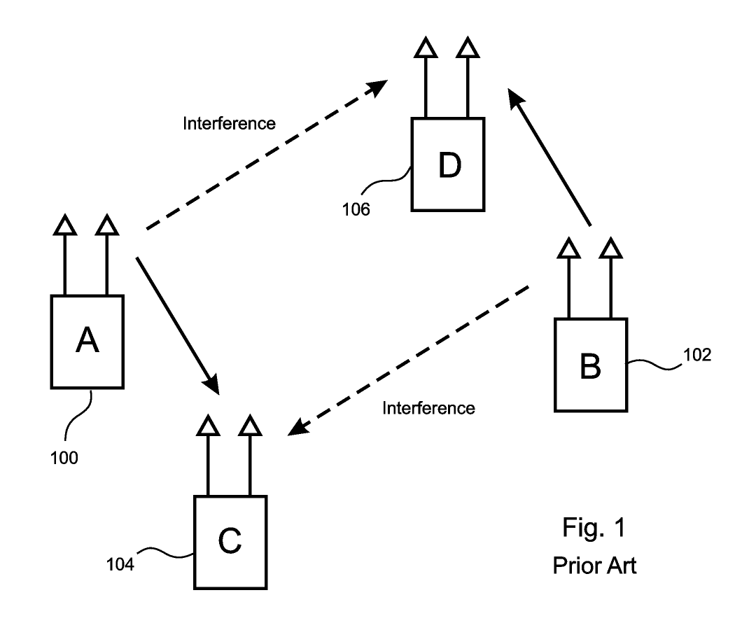

FIG. 2 is a simplified diagram illustrating beam-forming transmission between nodes that does not avoid interference with non-intended receivers, according to the prior art;

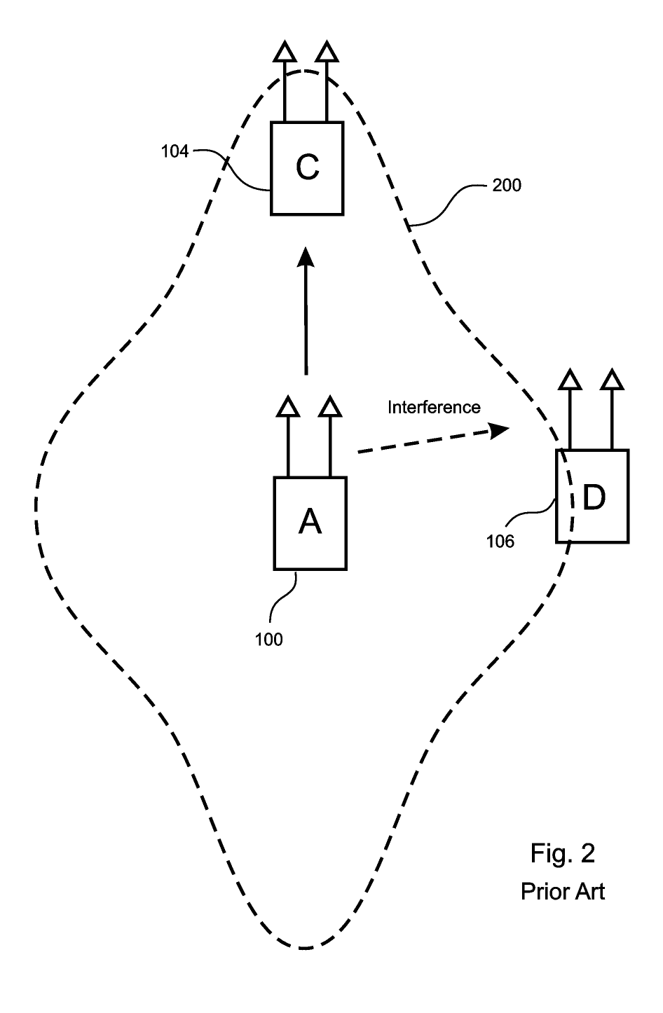

FIG. 3 is a diagram that is similar to FIG. 1, according to the prior art, but applies to a cellular communication network;

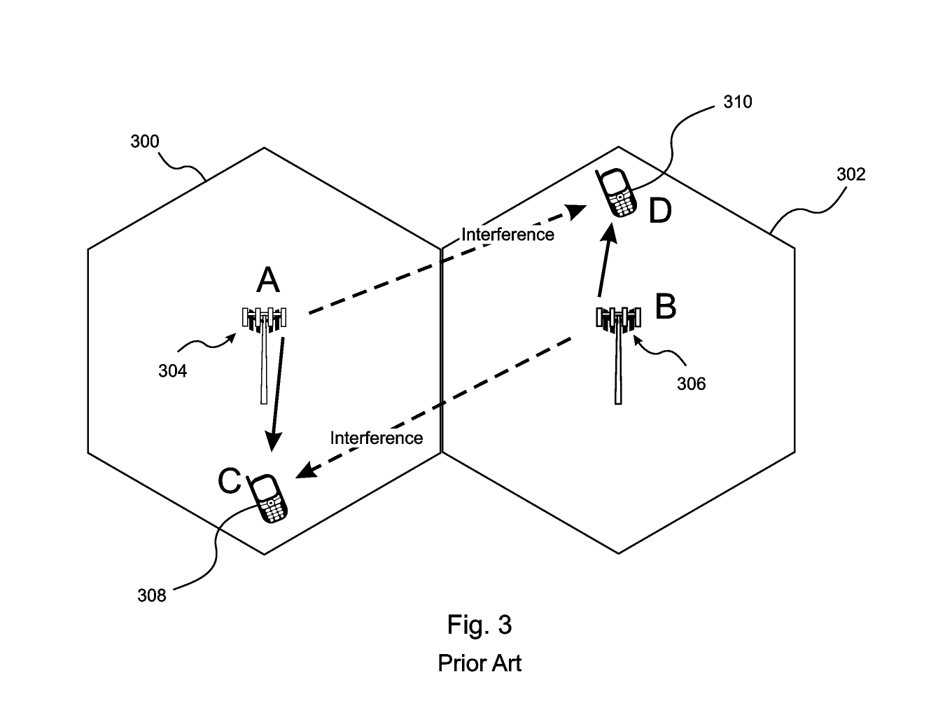

FIG. 4 illustrates receiving by a node of a signal from an interfering node in preparation for transmitting to an intended receiver according to an exemplary embodiment;

FIG. 5 illustrates transmitting by a transmitting node of a signal having a beam-formed spatial pattern that enhances signal strength at an intended receiver while minimizing signal strength at an interfering node, according to an exemplary embodiment;

FIG. 6 is a flow diagram that illustrates an exemplary method embodiment; and

FIG. 7 is a simplified block diagram of an exemplary system embodiment.

### DETAILED DESCRIPTION

Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

In the absence of high-speed links between nodes in a wireless network, it can be very difficult for a transmitting node to implement effective beam-forming, because of a lack of information about nodes that are not intended receivers but that may nevertheless be within the range of the transmission, referred to herein as “interfering nodes.” Specifically, the transmitting node may have no channel information or scheduling information regarding the interfering nodes.

However, a special case arises when the interfering nodes transmit and receive using the same spectrum, whereby channel and scheduling information regarding one or more interfering nodes can be determined from signals received from the interfering node(s), and effective transmit beam-forming can be implemented that maximizes signal at one or more intended receiving nodes while minimizing the signal at one or more interfering nodes.

When nodes transmit and receive using the same spectrum, the communication channels between them are reciprocal. Reciprocal communication channels allow a node to measure information about the channel conditions by receiving signals from other nodes in the network, and assuming that the same channel conditions will apply when transmitting to those other nodes. Scheduling can also be estimated, for example by assuming that nodes will receive approximately as often as they transmit, and/or by intercepting scheduling information from handshake signals and/or packet headers. Accordingly, transmit beam-forming can be optimized for maximum signal at intended receiving nodes and minimum signal at interfering nodes without providing high speed links between the nodes.

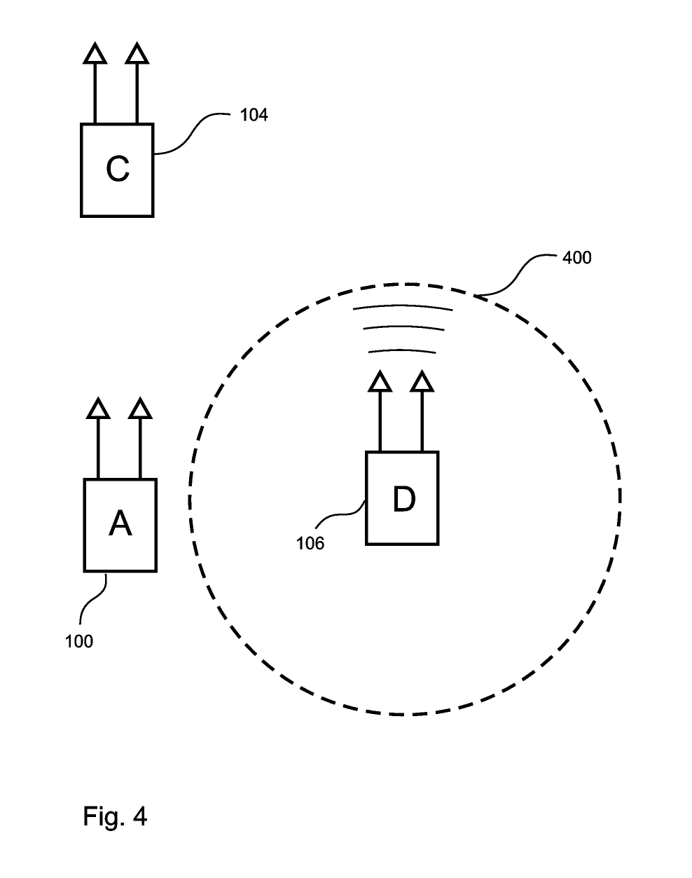

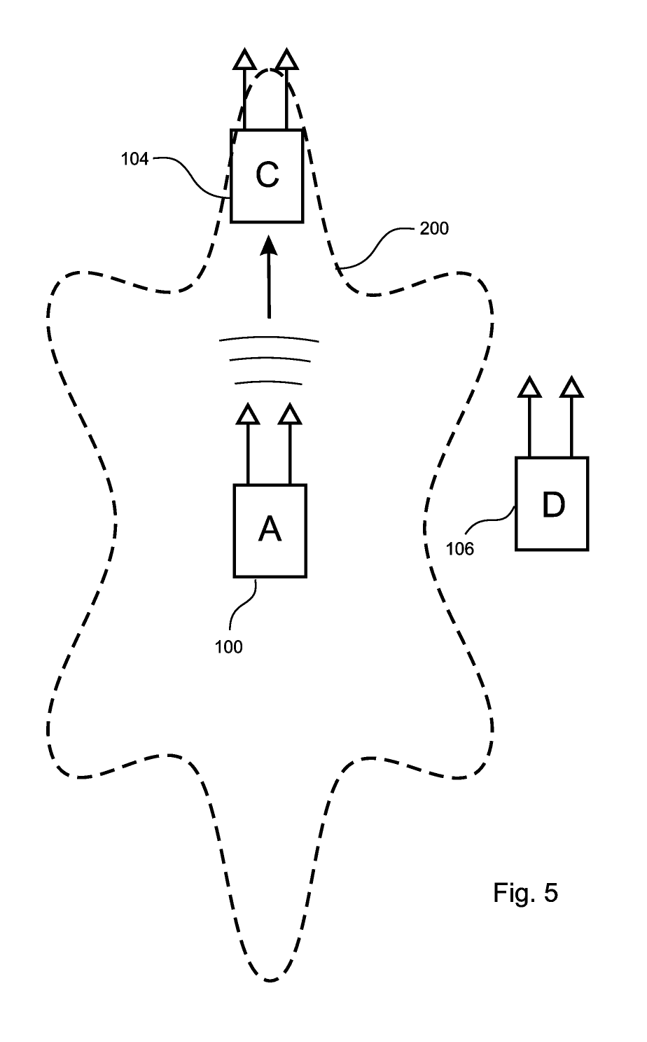

An example is illustrated in FIG. 4, where node A 100, which is preparing to send a transmission to intended receiver C 106, first detects a transmission 400 from interfering node D 106, and assumes that the interference channel 400 is reciprocal. As illustrated in FIG. 5, node A 100 then calculates a precoding matrix and transmits to node C 106 with a transmission spatial pattern 500 that optimizes signal strength at the intended receiver C 106, while minimizing signal strength at the interfering node D 108.

Wireless networks that implement Time Division Duplex or Time Division Multiple Access communication are examples of networks in which the nodes transmit and receive using the same spectrum. These networks operate by sharing the spectrum for each node's transmitter and receiver, but a node never transmits and receives at the same time. Another type of network is a full duplex system, in which the transmitter and receiver of a node utilize the same spectrum at the same time.

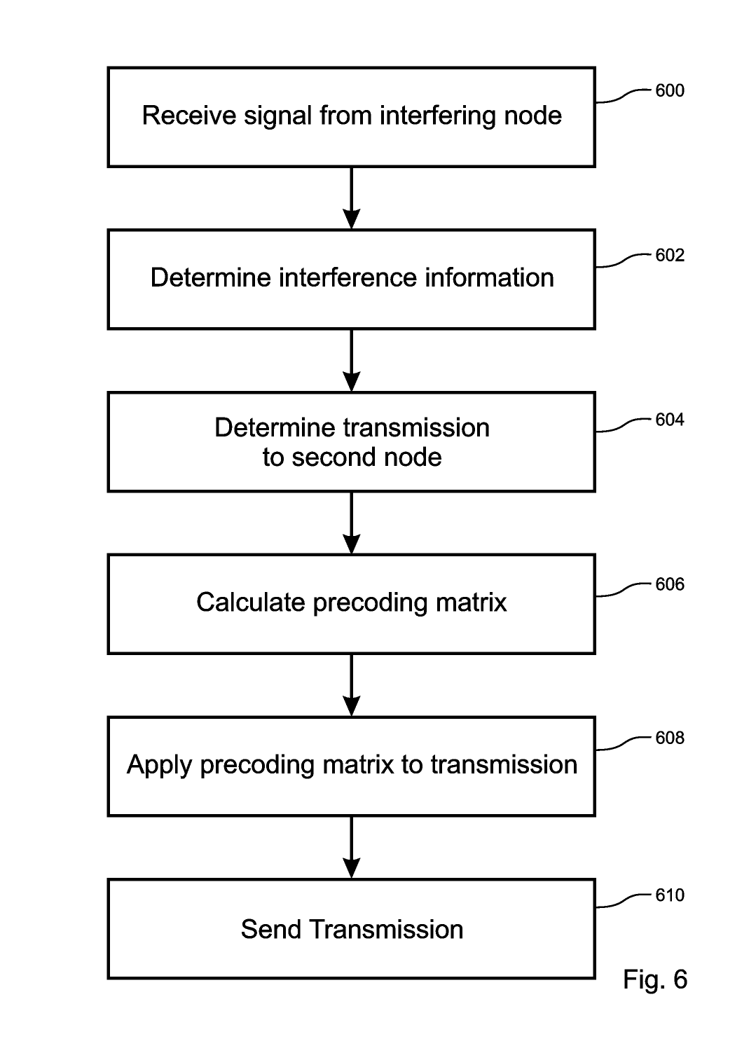

With reference to FIG. 6, according to exemplary embodiments of the method and system described herein, a wireless network node receives signals from one or more interfering nodes 600, and estimates the interference information for the interfering nodes 602 from subspace information derived from the received signals. The wireless network node then prepares to send a transmission to one or more selected receiving nodes 604 by calculating a precoding matrix 606 that optimizes signal at the intended receiving node(s) while minimizing signal at the interfering node(s). Finally, the preconding matrix is applied to the transmission 608, and the transmission is sent to the receiving node(s) 610.

Interference information can be calculated directly, such as by a direct channel estimate when feasible, or it can be determined from subspace information. Techniques for estimating the interference information from subspace information can include interference spatial covariance matrix estimation through sample matrix inversion, and angle of arrival estimation. These techniques do not require direct knowledge of the reference signals of the interfering node(s), and because the interfering node(s) transmit and receive using the same spectrum, the estimates are assumed to be reciprocal. In some embodiments, the interference information for all interfering nodes is incorporated into the precoding matrix. In other embodiments, the transmitting node determines which interfering node(s) are most likely to experience significant interference, isolates the interference information for only those interfering nodes, and incorporates only the interference information for those interfering nodes into the precoding matrix. Techniques that use this approach include highest eigenvectors and/or SVD of interference subspace.

Note that the term “precoding matrix” is used herein as a general term to summarize how a beam-forming spatial distribution is applied to a transmission. Generally, the transmission can be manipulated by either a digital or an analog precoding process that determines the phase, amplitude, and apportioning of the transmission channels to the transmitting antennae. A digital precoding process involves applying the precoding matrix to the transmission while the transmission is in a digital format, typically by representing the transmission as a vector of transmitting channels and multiplying the transmitting channels by the precoding matrix. The precoding matrix may be applied at any of various points in the digital transmit chain.

An analog precoding process typically involves using analog RF mixers and/or other analog RF components to apply the precoding matrix to the transmission after it has been converted to analog form. Both digital and analog precoding processes have the same effect of controlling the spatial pattern of the transmission.

As noted above, since receiving the signal from the interfering node(s) will precede the transmission to the intended receiving node(s) by some time interval, it is necessary to estimate and/or predict scheduling information regarding which interfering nodes will be receiving when the transmission is sent. The simplest approach is to assume that there will be no change between the receiving frequency and/or timing of the signals from the other nodes and the frequency and/or timing used in the sending of the transmission. A prediction of the future channel information for interfering nodes can also be constructed through averaging all previously calculated covariance matrices of interfering nodes.

These approaches effectively make the assumption that the wireless network nodes are transmitting more or less as frequently as they are receiving. Accordingly, adding persistence to the operating rules of the wireless network nodes can help to increase the probability of correctly predicting which interfering nodes will be receiving at the time of the transmission. The term “persistence” is used herein to refer to any strategy that biases the operating rules of the network nodes toward longer periods of transmitting and receiving, which allows better predictions of their future behavior.

Communication scheduling in many wireless networks is frequency dependent, whereby multiple nodes may be scheduled in the same frequency band. Accordingly, the precoding matrix can be frequency and/or time dependent. Frequency dependence can be of particular importance, since the transmitters and receivers use the same spectrum. When high channel gains are detected in a certain part of the spectrum, interference mitigation techniques can be enhanced in that part of the spectrum.

When determining the precoding matrix, it is necessary to balance the need for a strong signal at the intended receiver and the need to minimize the signal at unintended receivers. If there were no concern about interference, a precoding matrix would be chosen that simply maximized the signal strength, or capacity, at the intended receiver(s). However, incorporating knowledge of one or more interfering nodes into the precoding matrix requires a deviation from such an “absence of interference” decision. Various techniques can be used to find an optimal balancing of these requirements, depending on many factors. One approach is to optimize the precoding matrix for minimum interference with all unintended receivers. Another strategy is to identify the one or more unintended receivers that are most likely to experience interference, and then calculate a precoding matrix that will minimize the amplitude of the transmission for those unintended receivers.

Yet another strategy attempts to maximize the sum capacity to both the intended receiver(s) and the unintended “interfering” receivers. Other assumptions can be applied, such as an assumption regarding the base rate at the interfering nodes, and/or a simplifying assumption that all the rates without interference are the same. Maximizing sum capacity can be further modified through imposing constraints on the rates, such as a minimum rate constraint or a quality of service metric.

Various strategies can be used to predict scheduling information for interfering nodes, depending on the type of wireless network. For example, in a WiFi system operating in Request to Send (RTS)/Clear to Send (CTS) mode, the RTS and CTS handshake signals can be intercepted and used to obtain information about scheduling of subsequent DATA transmissions. In a WiFi system operating in a packet-switched mode, each packet includes a header that contains information about the intended receiver of the packet and the duration of the packet and/or of a stream of packets in a transmission. This information can be intercepted and used to obtain information about the length of the packet and about scheduling of subsequent packets. The packet length information can be further used to determine the remaining duration of the transmission, so that interference therewith can be avoided.

According to the prior art, when a node is transmitting in a WiFi network the other nodes in the network will typically avoid transmitting at the same time, so as to avoid interference. However, the method described herein makes it possible for a plurality of nodes to transmit simultaneously without self-interference, by enabling the transmitting nodes to direct transmission nulls towards unintended receivers.

In a TDD cellular uplink, a base station first receives signals from both connected user equipment in the cell and interfering user equipment in a neighboring cell. The received signals can include reference signals and/or data signals. In embodiments, the base station estimates channel information from the received signals, and forwards the channel information to the connected user equipment. Since it is a TDD cellular network, the channel information is reciprocal, which allows the measured interference covariance matrix to be used when calculating the precoding matrix. The user equipment then makes the assumption that every base station is receiving at all times, and incorporates the estimated channel information into the calculation of the precoding matrix, for example by attempting to maximize sum capacity.

In a TDD cellular downlink, the base station first receives uplink signals from connected user equipment in its cell, and from interfering user equipment in adjacent cells. The received signals may be reference signals or data signals. In embodiments, the base station forms a covariance matrix via a sample matrix that corresponds only with the interfering user equipment, where the sample matrix is determined by subtracting out the covariance matrix of the connected user equipment. Since it is a TDD cellular network, the channel information is reciprocal, which allows the interference covariance matrix to be used in calculating the precoding matrix. Since in a downlink there may be many user equipment handsets that are the intended receivers, in embodiments the interfering user equipment handsets that will suffer significant interference are identified via an SVD, and only information regarding those interfering handsets is included when calculating the covariance matrix, typically by using a sum capacity metric and also by estimating a probability that those interfering handsets will be receiving at the time the transmission is sent.

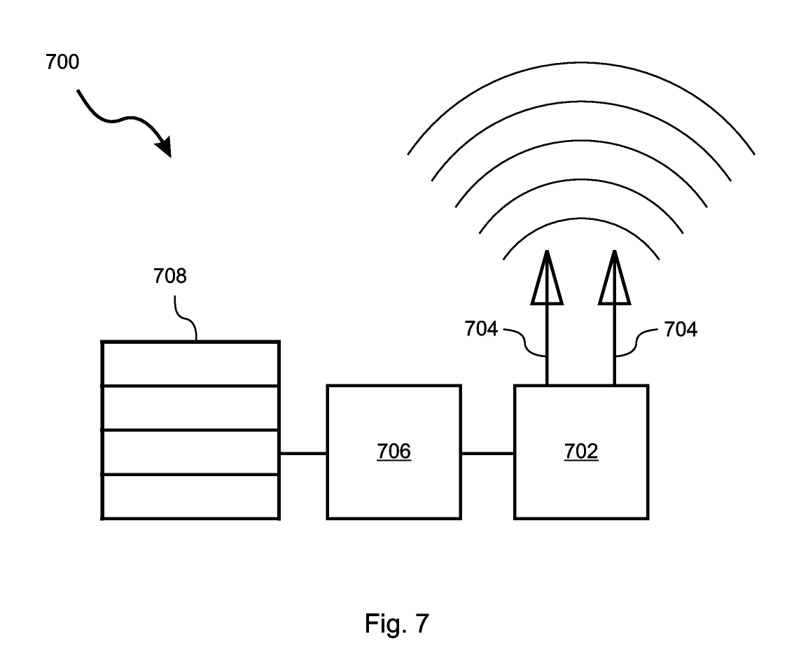

With reference to FIG. 7, the apparatus 700 described herein includes a transmitter 702 equipped with a plurality of antennae 704, a receiver 706, and a controller 708. The controller 708 is an instruction execution machine, apparatus, or device, and may comprise one or more of a microprocessor, a digital signal processor, a graphics processing unit, an application specific integrated circuit (ASIC), a field programmable gate array (FPGA), and the like. The controller 708 may be configured to execute program instructions stored in a memory and/or data storage (both not shown). The memory may include read only memory (ROM) and random access memory (RAM). The data storage may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data.

It is noted that the methods described herein can be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like may also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

The transmitter 702, receiver 706, and controller 708 are preferably incorporated into a transmitting node of a wireless network. In embodiments where the wireless network is a cellular network, the transmitting node can be a base station (“BS”) that operates in a networked environment using logical connections to one or more remote nodes. The remote node may be another BS, a user equipment (“UE”) such as a handset, a computer, a server, a router, a peer device, or another common network node. The base station may interface with a wireless network and/or a wired network. For example, wireless communications networks can include, but are not limited to, Code Division Multiple Access (CDMA), Time Division Multiple Access (TDMA), Frequency Division Multiple Access (FDMA), Orthogonal Frequency Division Multiple Access (OFDMA), and Single-Carrier Frequency Division Multiple Access (SC-FDMA). A CDMA network may implement a radio technology such as Universal Terrestrial Radio Access (UTRA), Telecommunications Industry Association's (TIA's) CDMA2000®, and the like. The UTRA technology includes Wideband CDMA (WCDMA), and other variants of CDMA. The CDMA2000® technology includes the IS-2000, IS-95, and IS-856 standards from The Electronics Industry Alliance (EIA), and TIA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, and the like. The UTRA and E-UTRA technologies are part of Universal Mobile Telecommunication System (UMTS). 3GPP Long Term Evolution (LTE) and LTE-Advance (LTE-A) are newer releases of the UMTS that use E-UTRA. UTRA, E-UTRA, UMTS, LTE, LTE-A, and GAM are described in documents from an organization called the “3rd Generation Partnership Project” (3GPP). CDMA2000® and UMB are described in documents from an organization called the “3rd Generation Partnership Project 2” (3GPP2). The techniques described herein may be used for the wireless networks and radio access technologies mentioned above, as well as other wireless networks and radio access technologies. Other examples of wireless networks include, for example, a BLUETOOTH network, a wireless personal area network, and a wireless 802.11 local area network (LAN).

In some embodiments, a communication interface may include logic configured to support direct memory access (DMA) transfers between memory and other devices.

It should be understood that the arrangement of elements illustrated in FIG. 7 is but one possible implementation, and that other arrangements are possible. It should also be understood that the various system components (and means) defined by the claims, described below, and illustrated in the various block diagrams represent logical components that are configured to perform the functionality described herein. For example, one or more of these system components (and means) can be realized, in whole or in part, by at least some of the components illustrated in the arrangement of hardware device 700. In addition, while at least one of these components is implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 7. Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

To facilitate an understanding of the subject matter described, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. One of ordinary skill in the art should appreciate after learning the teachings related to the claimed subject matter contained in the foregoing description that variations of those preferred embodiments may become apparent to those of ordinary skill in the art upon reading the foregoing description. The inventor intends that the claimed subject matter may be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

1. A method of operating a first wireless network node having N transmitting antennae, the method comprising:
receiving a signal from an interfering node to which the first wireless network node is not connected, wherein the first wireless network node is a base station and the interfering node is a mobile device not served by the base station;
determining, from the received signal, interference information that pertains to the interfering node;
determining a transmission to be sent to a second wireless network node, said transmission including M transmission channels, wherein the second wireless network node is a mobile device served by the base station;
calculating a precoding matrix based at least in part on the interference information, said precoding matrix having dimensions M and N, said precoding matrix being calculated according to a precoding strategy;
applying the precoding matrix to the transmission, thereby determining a phase, amplitude, and apportioning of the transmission channels to the transmitting antennae that impose a spatial transmission pattern on the transmission, said spatial pattern being configured to reduce interference of the transmission at the interfering node; and
sending the transmission to the second wireless network node.

2. The method of claim 1, wherein determining the interference information includes interference spatial covariance matrix estimation through sample matrix inversion.

3. The method of claim 1, wherein determining the interference information includes an angle of arrival estimation.

4. The method of claim 1, wherein the precoding matrix is at least one of time dependent and frequency dependent.

5. The method of claim 1, wherein at least one of a phase and an amplitude of an analog representation of the transmission is adjusted according to the precoding matrix.

6. The method of claim 1, wherein said precoding strategy includes at least one of:
minimizing an amplitude of the transmission at a location of the interfering node;
averaging previously calculated covariance matrices;
selecting one or more strong interferers for which the amplitude of the transmission will be minimized; and
maximizing a sum capacity of the transmission.

7. The method of claim 6, wherein selecting the one or more strong interferers includes at least one of:
choosing highest eigenvectors of the interference information; and
determining a singular value decomposition of the interference information.

8. The method of claim 6, wherein maximizing the sum capacity includes using a maximum sum capacity formula that is modified according to at least one of a quality of service and a minimum rate constraint metric.

9. The method of claim 1, wherein the precoding matrix is calculated at least in part according to at least one of:
a predicted or estimated signal-to-noise ratio of the transmission at the second node; and
a signal-to-interference ratio of the transmission at the interfering node.

10. The method of claim 1, wherein calculating the precoding matrix includes an iterative calculation based on information regarding at least one node that is adjacent to the first node.

11. The method of claim 1, wherein the precoding matrix is calculated at least in part according to predictive information that provides information regarding future transmissions in the network.

12. The method of claim 11, wherein said predictive information is derived from at least one of:
handshake signals exchanged between nodes in the wireless network; and
information regarding transmission scheduling included in headers of packets exchanged between nodes in the wireless network.

13. The method of claim 1, wherein the nodes in the wireless network use the same spectrum for both transmitting and receiving by implementing at least one of time division duplex communication, time division multiple access communication, and full duplex communication.

14. The method of claim 1, wherein the nodes of the wireless network are operated according to a rule set that biases at least one of scheduling and transmission decisions towards persistence.

15. A first wireless network node comprising:
a transmitter;
a receiver;
N transmitting antennae; and
a controller coupled to the transmitter, receiver, and antennae, together configured to:
receive a signal from an interfering node to which the first wireless network node is not connected, wherein the first wireless network node is a base station and the interfering node is a mobile device not served by the base station;
determine, from the received signal, interference information that pertains to the interfering node;
determine a transmission to be sent to a second wireless network node, said transmission including M transmission channels, wherein the second wireless network node is a mobile device served by the base station;
calculate a precoding matrix based at least in part on the interference information, said precoding matrix having dimensions M and N, said precoding matrix being calculated according to a precoding strategy;
apply the precoding matrix to the transmission, thereby determining a phase, amplitude, and apportioning of the transmission channels to the transmitting antennae that impose a spatial transmission pattern on the transmission, said spatial pattern being configured to reduce interference of the transmission at the interfering node; and
send the transmission to the second wireless network node.

16. The first wireless network node of claim 15, wherein the first wireless network node is configured to determine the interference information using interference spatial covariance matrix estimation through sample matrix inversion.

17. The first wireless network node of claim 15, wherein the first wireless network node is configured to determine the interference information using an angle of arrival estimation.

18. The first wireless network node of claim 15, wherein the precoding matrix is at least one of time dependent and frequency dependent.

19. The first wireless network node of claim 15, wherein at least one of a phase and an amplitude of an analog representation of the transmission is adjusted according to the precoding matrix.

20. The first wireless network node of claim 15, wherein said precoding strategy includes at least one of:
minimizing an amplitude of the transmission at a location of the interfering node;
averaging previously calculated covariance matrices;
selecting one or more strong interferers for which the amplitude of the transmission will be minimized; and
maximizing a sum capacity of the transmission.

21. The first wireless network node of claim 20, wherein selecting the one or more strong interferers includes at least one of:
choosing highest eigenvectors of the interference information; and
determining a singular value decomposition of the interference information.

22. The first wireless network node of claim 20, wherein maximizing the sum capacity includes using a maximum sum capacity formula that is modified according to at least one of a quality of service and a minimum rate constraint metric.

23. The first wireless network node of claim 15, wherein the first wireless network node is configured to calculate the precoding matrix at least in part according to at least one of:
a predicted or estimated signal-to-noise ratio of the transmission at the second node; and
a signal-to-interference ratio of the transmission at the interfering node.

24. The first wireless network node of claim 15, wherein the first wireless network node is configured to calculate the precoding matrix using an iterative calculation based on information regarding at least one node that is adjacent to the first node.

25. The first wireless network node of claim 15, wherein the first wireless network node is configured to calculate the precoding matrix at least in part according to predictive information that provides information regarding future transmissions in the network.

26. The first wireless network node of claim 25, wherein said predictive information is derived from at least one of:
handshake signals exchanged between nodes in the wireless network; and
information regarding transmission scheduling included in headers of packets exchanged between nodes in the wireless network.

27. The first wireless network node of claim 15, wherein the nodes in the wireless network use the same spectrum for both transmitting and receiving by using at least one of time division duplex communication, time division multiple access communication, and full duplex communication.

28. The first wireless network node of claim 15, wherein the nodes of the wireless network are operated according to a rule set that biases at least one of scheduling and transmission decisions towards persistence.

29. A non-transitory computer readable medium storing a computer program executable by a machine, for operating a first wireless network node having N transmitting antennae, the computer program comprising executable instructions for:
receiving a signal from an interfering node to which the first wireless network node is not connected, wherein the first wireless network node is a base station and the interfering node is a mobile device not served by the base station;
determining, from the received signal, interference information that pertains to the interfering node;
determining a transmission to be sent to a second wireless network node, said transmission including M transmission channels, wherein the second wireless network node is a mobile device served by the base station;
calculating a precoding matrix based at least in part on the interference information, said precoding matrix having dimensions M and N, said precoding matrix being calculated according to a precoding strategy;
applying the precoding matrix to the transmission, thereby determining a phase, amplitude, and apportioning of the transmission channels to the transmitting antennae that impose a spatial transmission pattern on the transmission, said spatial pattern being configured to reduce interference of the transmission at the interfering node; and
sending the transmission to the second wireless network node.
